(19) United States
(12) Patent Application Publication
(10) Pub. No.: US 2024/0331660 A1
(43) Pub. Date: Oct. 3, 2024

(54) PROGRAM, TERMINAL CONTROL METHOD, TERMINAL, INFORMATION PROCESSING METHOD, AND INFORMATION PROCESSING DEVICE

(71) Applicant: SmartNews, Inc., Tokyo (JP)

(72) Inventors: Kosuke INOUE, Tokyo (JP); Akiko KUNUGI, Tokyo (JP)

(73) Assignee: SmartNews, Inc., Tokyo (JP)

(21) Appl. No.: 18/621,279

(22) Filed: Mar. 29, 2024

(30) Foreign Application Priority Data
Mar. 31, 2023 (JP) 2023-058998

(51) Int. Cl. G09G 5/377; G06F 3/0482; G06F 3/14

(52) U.S. Cl. CPC G09G 5/377; G06F 3/0482; G06F 3/14

(57) ABSTRACT

An exemplary method includes obtaining an image captured by a camera from among a plurality of cameras installed at predetermined locations; and displaying on a display unit a map on which each of a plurality of image objects indicating a location of each of the plurality of cameras are superimposed at a position corresponding to each of the predetermined locations, and an image captured by at least one of the plurality of cameras is displayed on the display unit together with the map.

### CROSS-REFERENCE TO RELATED APPLICATION

The present application claims priority based on Japanese Patent Application No. 2023-58998 filed on Mar. 31, 2023, the entire disclosure of which is incorporated by reference herein.

### TECHNICAL FIELD

The present disclosure relates to a technique for displaying an image and a map on a single screen.

### RELATED ART

Conventionally, a technique is known for displaying an image and a map on a single screen. Patent Document 1 discloses a technique for displaying on a map a camera icon indicative of a location of a camera. When a mouse cursor is moved over the camera icon, a preview image of an image captured by a camera corresponding to the camera icon is displayed. In addition, when a designated mouse operation is performed on the camera icon, an image recorded by the camera is displayed.

### PRIOR ART

### Patent Document

PATENT DOCUMENT 1: JP 2014-49865 A

### SUMMARY

### Problem to be Solved

In the art described in Patent Document 1, a drawback exists in that it is difficult for a user to search for a live camera image captured at a location that the user wishes to view.

The present disclosure provides a technique that enables a user to easily select on a map a live camera image of a location that the user wishes to view.

SOLUTION

According to one aspect of the disclosure, there is provided a method including: obtaining an image captured by a camera among a plurality of cameras installed at predetermined locations; and displaying on a display unit a map on which each of a plurality of image objects indicating a location of each of the plurality of cameras are superimposed at a position corresponding to each of the predetermined locations, wherein the image captured by at least one of the plurality of cameras is displayed on the display unit together with the map.

According to another aspect of the disclosure, there is provided a computer-readable non-transitory storage medium storing a program causing a computer device to execute a process, the process including: obtaining an image captured by a camera from among a plurality of cameras installed at predetermined locations; and displaying on a display unit a map on which each of a plurality of image objects indicating a location of each of the plurality of cameras are superimposed at a position corresponding to each of the predetermined locations, wherein the image captured by at least one of the plurality of cameras is displayed on the display unit together with the map.

According to yet another aspect of the disclosure, there is provided an information processing device including: a processor, a memory operably connected to the processor, and a display device operably connected to the processor, wherein the processor is configured to obtain an image captured by a camera from among a plurality of cameras installed at predetermined locations, and control the display device to display a map on which each of a plurality of image objects indicating a location of each of the plurality of cameras is superimposed at a position corresponding to each of the predetermined locations, and the image captured by at least one of the plurality of cameras is displayed on the display device together with the map.

According to yet another aspect of the disclosure, there is provided a method including: communicating with a user terminal having a display device; obtaining an image captured by a camera from among a plurality of cameras installed at predetermined locations; and controlling the display device to display a map on which each of a plurality of image objects indicating a location of each of the plurality of cameras are superimposed at a position corresponding to each of the predetermined locations, wherein the image captured by at least one of the plurality of cameras is displayed on the display device together with the map.

According to yet another aspect of the disclosure, there is provided an information processing device including: a processor, and a memory operably connected to the processor, wherein the processor is configured to: communicate with a user terminal having a display device; obtain an image captured by a camera from among a plurality of cameras installed at predetermined locations; and control the display device to display a map on which each of a plurality of image objects indicating a location of each of the plurality of cameras are superimposed at a position corresponding to each of the predetermined locations, wherein the image captured by at least one of the plurality of cameras is displayed on the display device together with the map.

### ADVANTAGOUS EFFECTS

According to the present invention, a user can easily select on a map a live camera image of a place that the user wishes to view.

### BRIEF DESCRIPTION OF THE DRAWINGS

FIG. 1 shows a configuration of an information processing system according to an embodiment;

FIG. 2 is a diagram illustrating the functional configuration of the information processing system;

FIG. 3 is a diagram illustrating a hardware configuration of a server;

FIG. 4 shows a hardware configuration of a user terminal;

FIG. 5 is a sequence chart exemplifying a process for displaying on a single display screen a current live camera image and a map image;

FIG. 6 illustrates a network camera database;

FIG. 7 is illustrates an image object database;

FIG. 8 is a diagram illustrating a display screen of an application;

FIG. 9 is also a diagram illustrating a display screen of an application;

FIG. 10 is a sequence chart exemplifying a process for displaying on a single display screen a map image and a live camera image with rain cloud radar;

FIG. 11 is a diagram illustrating a display screen of an application; and

FIG. 12 is a diagram illustrating a display screen of an application.

### DETAILED DESCRIPTION

### 1. Configuration

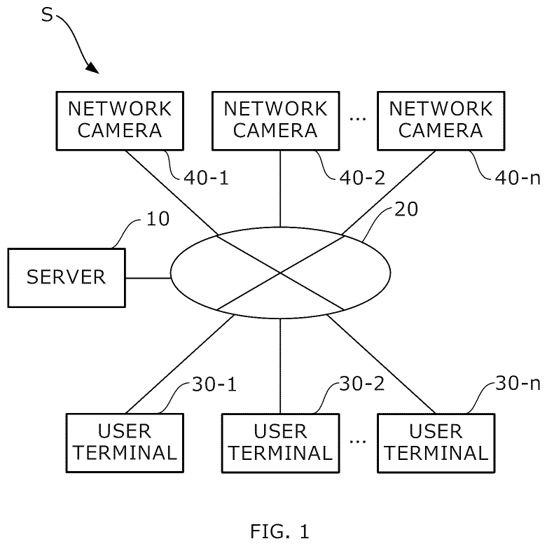

FIG. 1 is an illustrative overview of an information processing system S according to an embodiment. The information processing system S includes a server 10, a network 20, a plurality of user terminals 30-1, 30-2, . . . , 30-n (hereinafter, collectively referred to as user terminals 30), and a plurality of network cameras 40-1, 40-2, . . . , 40-n (hereinafter, collectively referred to as network cameras 40). The server 10 and the user terminals 30 are connected via the network 20; as are the server 10 and the network cameras 40.

The network 20 is a computer network such as the Internet. Each of the plurality of user terminals 30 and the plurality of network cameras 40 are connectable to the network 20, and when connected thereto can communicate with the server 10.

The network cameras 40 are each installed at a freely decided location, and capture a still or moving image (hereinafter, a still image and a moving image are collectively referred to simply as an image). The frame rate of the network camera 40 is preset by an administrator or the like of the network camera 40. The network camera 40 includes a storage unit (not shown in the figures), which is used to store image data. The network camera 40 transmits to the server 10 a captured image (corresponding to the live camera image).

An example of the user terminal 30 is a mobile information terminal, such as a smartphone, which is equipped to communicate wirelessly and can be carried by a user. However, the user terminal 30 is not limited thereto, and any terminal capable of communicating via the network 20, such as a laptop PC, may be used as the user terminal 30. The user terminal 30 communicates with the server 10 and displays information transmitted from the server 10 on a display (corresponding to a display unit) of the user terminal 30. The user terminal 30 displays an image object superimposed on a map image on the display of the user terminal 30. The position of the image object on the map image corresponds to a location in real space of the network camera 40 corresponding to the map image. The user terminal 30 displays an image captured by the network camera 40 and corresponding to the image object selected by the user of the user terminal 30.

The server 10 (an example of an information processing device) transmits to the user terminal 30 map information of an area designated by the user of the user terminal 30. The server 10 transmits an image captured by the network camera 40 to the user terminal 30. Although a single server 10 is illustrated in FIG. 1, functions of the server 10 can be implemented by a plurality of servers, with processing distributed among them.

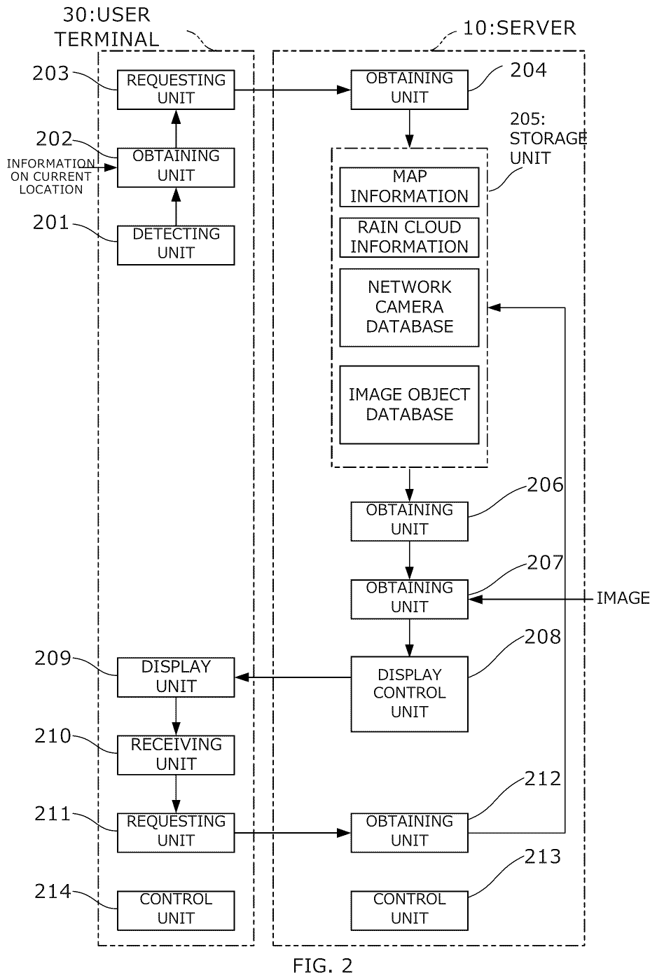

FIG. 2 shows a functional configuration of the information processing system S. The information processing system S includes a detecting unit 201, an obtaining unit 202, a requesting unit 203, an obtaining unit 204, a storage unit 205, an obtaining unit 206, an obtaining unit 207, a display control unit 208, a display unit 209, a receiving unit 210, a requesting unit 211, an obtaining unit 212, a control unit 213, and a control unit 214. Each of the obtaining unit 204, the storage unit 205, the obtaining unit 206, the obtaining unit 207, the display control unit 208, the obtaining unit 212, and the control unit 213 are implemented in the server 10. Each of the detecting unit 201, the obtaining unit 202, the requesting unit 203, the displaying unit 209, the receiving unit 210, the requesting unit 211, and the control unit 214 are implemented in the user terminal 30.

Functions of the server 10 will now be described. The storage unit 205 stores various types of data including map information (not shown in the figures), rain cloud information (not shown in the figures), a network camera database, an image object database, and image object data.

The obtaining unit 204 obtains from the user terminal 30 a request to display a map image, and also obtains from the user terminal 30 information on a current location of the user terminal 30. The obtaining unit 206 obtains the information on a current location of the network camera 40 (hereinafter, referred to as camera location information) from the network camera database stored in the storage unit 205. The obtaining unit 206 obtains information related to the image object (hereinafter, referred to as image object information) from the image object database stored in the storage unit 205. The image object is an object that indicates a location of the network camera 40 in the map image. The image object information includes, for example, a file name of the image object. The obtaining unit 206 also obtains map information. The map information is configured based on the information on a current location of the user terminal 30, which is transmitted from the user terminal 30. More specifically, the map information is information on a current location of the user terminal 30 transmitted by the requesting unit 203 of the user terminal 30 to the server 10.

The obtaining unit 207 obtains a live camera image captured by the network camera 40. The display control unit 208 controls display on the user terminal 30 of an image object, a map image, and a live camera image. That is, the display control unit 208 transmits the image object, the map image, and the live camera image to the user terminal 30. The obtaining unit 212 obtains requests from the requesting unit 211 of the user terminal 30, and the controlling means 213 performs various controls.

Functions of the user terminal 30 will now be described. The detecting unit 201 detects activation of an application program (hereinafter, referred to as an application) that is managed by the server 10.

The obtaining unit 202 obtains the information on a current location of the user terminal 30 from the positioning system 307. That is, the obtaining unit 202 obtains information indicating the current terrestrial location of the user terminal 30. The requesting unit 203 requests the server 10 for a map image to be displayed on the display 3051 of the user terminal 30. The requesting unit 203 transmits the information on a current location obtained from the positioning system 307 by the user terminal 30 to the server 10 via the communication unit 304.

The display unit 209 displays the image object, the map image, and the live camera image transmitted from the server 10 on the display 3051 of the user terminal 30. The display unit 209 displays a map image in which the image object is superimposed on a position corresponding to the location in real space of the network camera 40. Further, the display unit 209 displays the live camera images captured by the plurality of network cameras 40 installed at the locations included in the map image, together with the map image, on a single display screen. Thus, a live camera image and a map image are together displayed on a single display screen. Moreover, such an image display includes display of a plurality of images, some of which are superimposed on other images, on a single display screen. For example, a part of or all of one of the live camera images and the map image may be displayed in superimposition.

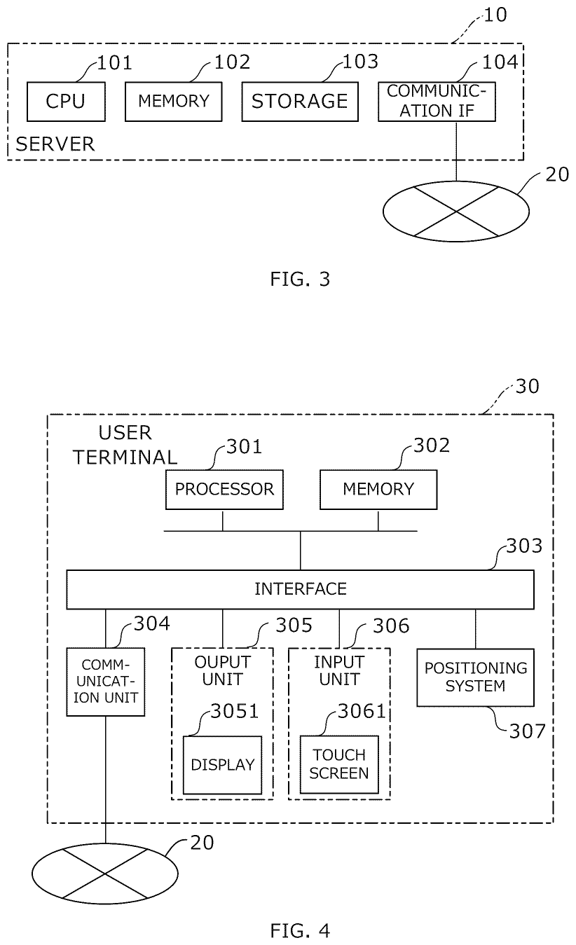

FIG. 3 shows an exemplary hardware configuration of the server 10. The server 10 is a computer device having a CPU (Central Processing Unit) 101, a memory 102, a storage 103, and a communication IF (Interface) 104. The CPU 101 is a processor that executes programs to perform various operations and controls other hardware elements of the server 10. The memory 102 is a main storage device that functions as a work area when the CPU 101 executes a program. The storage 103 is a nonvolatile auxiliary storage device that stores various programs and data. The communication IF 104 is a communication device that communicates with other devices in accordance with a predetermined communication standard (e.g., Ethernet).

In this example, the storage 103 stores a program (hereinafter referred to as a “server program”) that causes the computer device to function as the server 10 in the information processing system S. When CPU 101 executes the server program, the functions shown in FIG. 2 are implemented in the computer device. When the CPU 101 is executing the server program, at least one of the memory 102 and the storage 103 is an example of the storage unit 205, the CPU 101 is an example of the obtaining unit 206 and the control unit 213, and the communication IF 104 is an example of the obtaining unit 204, the obtaining unit 207, the display control unit 208, and the obtaining unit 212.

FIG. 4 shows a hardware configuration of user terminal 30. The user terminal 30 is a computer device that includes a processor 301, a memory 302, an interface 303, a communication unit 304, an output unit 305, an input unit 306, and a positioning system 307. Each of these elements is connected to and communicates with each other by way of, for example, a bus.

The processor 301 controls each unit of the user terminal 30 by reading and executing a computer program (hereinafter, simply referred to as a program) stored in the memory 302. The processor 301 is, for example, a CPU (Central Processing Unit). The memory 302 is a storage unit that stores an operating system, various programs, data, and the like that are loaded into the processor 301. The memory 302 has a RAM (Random Access Memory) and a ROM (Read Only Memory). The memory 302 may include a solid-state drive, a hard disk drive, or the like. The interface 303 is a communication circuit that operatively connects the processor 301 to the communication unit 304, the output unit 305, the input unit 306, and the positioning system 307. The communication unit 304 controls communication with the server 10 via the network 20. The output unit 305 includes a display unit such as a display device, and an audio output unit such as a speaker, for output of images, characters, and sounds. More specifically, in the present embodiment the output unit 305 includes the display 3051. The display 3051 is, for example, a flat panel display such as a liquid crystal display or an organic EL display, and outputs images or characters. The input unit 306 is an operation unit including a keyboard, a mouse, or the like, for inputting a variety of information in accordance with instructions provided by the user. In the present embodiment, the input unit 306 includes a touch screen 3061. The touch screen 3061 is an electronic component such as a touch pad in which a position input device is combined with a display 3051, which is a flat panel display, and is an input device that accepts input from a user by touching a display portion on a screen. The positioning system 307 is, for example, a satellite positioning system such as a GPS (Global Positioning System), and is used for determining a terrestrial location of the system.

The processor 301 executes the program to implement at the user terminal 30 the functions shown in FIG. 2. When the processor 301 is executing the program, the processor 301 is an example of the detecting unit 201, the obtaining unit 202, the receiving unit 210, and the control unit 214; the communication unit 304 is an example of the requesting unit 203 and the requesting unit 211; and the display 3051 is an example of the display unit 209.

In the present embodiment, a smart phone is used as the user terminal 30, but a PC (personal computer), a tablet PC, or the like may be used. The user terminal 30 may also be a desktop computer.

### 2. Operation

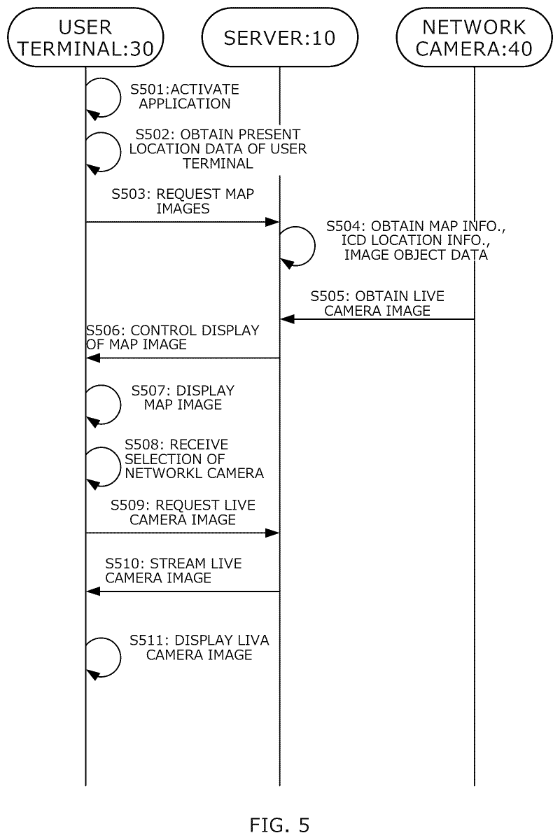

FIG. 5 is a sequence chart illustrative of a one-screen display process of a current live camera image and a map image. The live camera image is an image currently being captured by the network camera 40 (hereinafter, referred to as a current live camera image) or is an image that was captured in the past (hereinafter, referred to as a past live camera image). Among the past live camera images captured by the network camera 40, live camera images captured within a predetermined period are stored in the storage unit 205 of the server 10. The predetermined period is determined in advance by an administrator or the like of the application. The information processing system S is a system that causes the display 3051 of the user terminal 30 to display the current live camera image and the map image on a single display screen, and executes the processing illustrated in FIG. 5. That is, in the information processing system S, the processor 301 of the user terminal 30 displays a map in which an image object that indicates a location of each of the cameras installed at a plurality of predetermined locations is superimposed at a position corresponding to a predetermined location, and executes processing to display images captured by the plurality of cameras installed at locations included in the map on a single display screen together with the map. Further, in the information processing system S, the server 10 controls the display to display, on the display 3051 of the user terminal 30, a map in which an image object that indicates the location of each of the cameras installed at the plurality of predetermined locations is superimposed on a position corresponding to the predetermined location, and performs processing to control the display such that there are displayed on a single display screen together with the map, images captured by the plurality of cameras installed at locations included in the map displayed on the display 3051 of the user terminal 30.

At step S501, the detecting unit 201 of the user terminal 30 detects activation of the application. If activation of the application is detected, the user terminal 30 displays a screen including a map image and a live camera image as an initial screen.

At step S502, the obtaining unit 202 of the user terminal 30 obtains the present location data of the user terminal 30 from the positioning system 307.

At step S503, the requesting unit 203 of the user terminal 30 requests the server 10 to display the map images on the display 3051 of the user terminal 30. The request includes parameters related to the map display. The parameters related to the map display include the present location information of the user terminal 30 obtained at step S502 and the scale of the map image in the user terminal 30. The obtaining unit 204 of the server 10 obtains, from the user terminal 30, a request for data to display a map image on the display 3051 of the user terminal 30.

At step S504, the obtaining unit 206 of the server 10 obtains map information, image-capturing-device location information, and image-object data. The camera location information is obtained from the network camera database. The data of the image object is obtained from the storage unit 205 with reference to the image object information database. The map information is map information stored in the storage unit 205 and includes a map image. If map information corresponding to the information on a current location is not stored in the storage unit 205, the map information is obtained from an external server in charge of the map information, and the obtained map information is then stored in the memory 302. The obtaining unit 206 of the server 10 specifies the display area of the map image in the user terminal 30 by using the present location information of the user terminal 30 and the scale of the map image in the user terminal 30 obtained at step S503. At step S504, the display range of the map image is a range centered on the present location of the user terminal 30. In this case, the current location of the user terminal 30 is the reference point for the map that is displayed. Namely, obtaining the information on a current location of the user terminal 30 at step S502 corresponds to receiving designation of the reference point of the map. Further, the obtaining unit 206 of the server 10 obtains, from the network camera database, the camera location information related to the network camera 40 located within the specified display range.

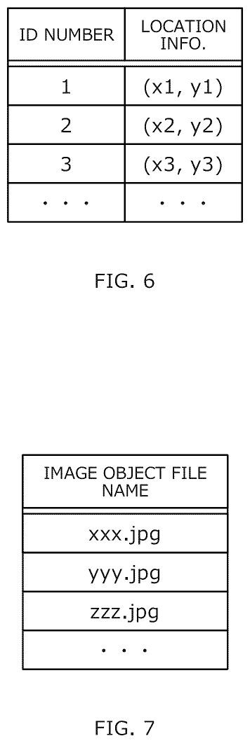

FIG. 6 shows an example of the network camera database. The network camera database stores camera location information. The camera location information includes, for example, an identification number (or a camera ID) and location information. The identification number is a number that uniquely identifies the network camera 40. An identification number is assigned to each network camera 40. The location information indicates a location at which the network camera 40 is present, and is represented by latitude and longitude coordinates, for example.

FIG. 7 shows an example of the image object database. The image object database stores image object information. The image object information includes an image object file name, for example. The image object file name is a file name of the image object. The image object database stores a plurality of image object file names. The type of image object to be displayed by being superimposed on the map image can be determined in accordance with a shooting target category of the network camera 40. The category of the imaging target can be freely set by an administrator or the like of the information processing system S. Examples of the category of the shooting target include “buildings,” “mountains,” “rivers,” “nature,” “people,” “public facilities,” “parks,” “stations,” “roads,” “intersections,” and “parking lots.”

At step S505, the obtaining unit 207 of the server 10 obtains the live camera images from the storage unit 205. At this time, network cameras 40 that are targets for obtaining live images are network cameras 40 located within the display area specified at step S504. Each network camera 40 continuously streams captured live images to the server 10. The server 10 stores the live camera images received from the network cameras 40 in the storage unit 205.

At step S506, the display control unit 208 of the server 10 controls display of a map image in which image objects are superimposed on the user terminal 30. Specifically, the display control unit 208 of the server 10 transmits the location information of the image object in the map image, the data of the image object, and the data of the map image to the user terminal 30. The position of the image object in the map image corresponds to a location (corresponds to a predetermined location) in the real space of the network camera 40 that is present in the area corresponding to the map image. That is, transmitting the location information of the image object in the map image corresponds to transmitting the location information of the network camera 40. The display control unit 208 of the server 10 controls the user terminal 30 to display the live camera images obtained from the plurality of network cameras 40 obtained at step S505, together with the map images, on one display screen. Specifically, data of the live camera images of the plurality of network cameras 40 is transmitted to the user terminal 30. In this example, the live camera images transmitted to the user terminal 30 are still images that correspond to each of the plurality of network cameras 40. The still images are thumbnail images, and are automatically generated by the server 10. The thumbnail images may be previous live camera images that are stored in the storage unit 205, for example. Upon receiving the data from the server 10, the display unit 209 of the user terminal 30 displays (at step S507) the image object, the map image, and the present live camera image on one display screen.

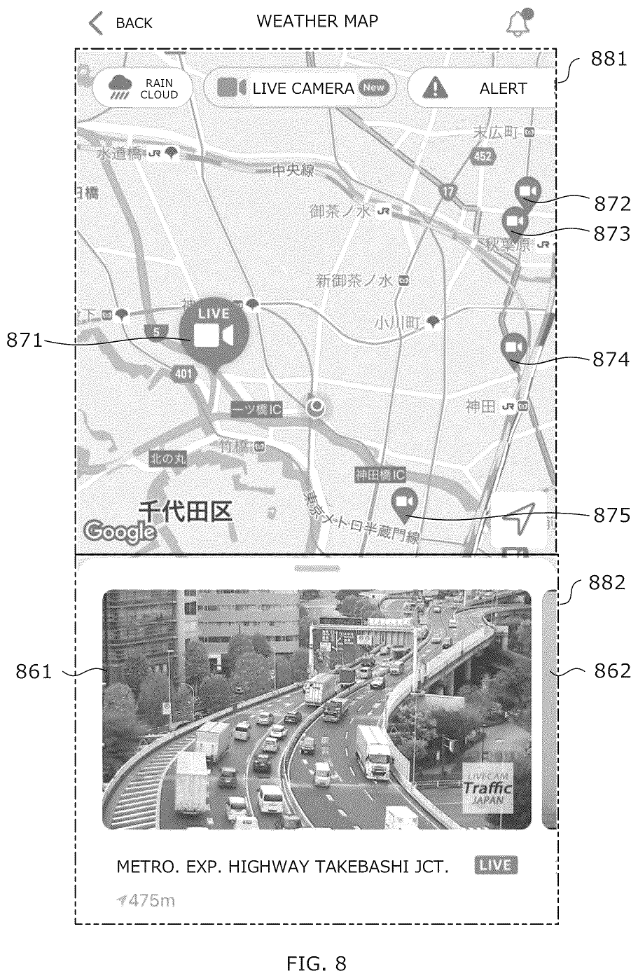

FIG. 8 shows an example of an application screen. The screen includes an area 881 and an area 882. The area 881 is an area for displaying a map image. The area 882 is an area for displaying a plurality of live camera images. The live camera images displayed in the area 882 are live camera images from the network cameras 40 located within the display area specified at step S504. If, for example, the number of network cameras 40 located within the display range is ten, live camera images from the ten cameras 40 are displayed in the area 882. Responsive to a user operation in the area 882, the user terminal 30 selects one live camera image in the area 882. Namely, the user terminal 30 selects one network camera 40. In other words, the area 882 corresponds to a selection area that receives selection of the network camera 40 from the user.

In this example, the area 882 displays a plurality of live camera images in a carousel format. That is, the plurality of live camera images are arranged in one direction (for example, horizontally), and their positions change in sequence responsive to an operation made by the user. The area of each of the live camera images is standardized relative to each other. A width of one live camera image is greater than half the width of area 882. At least two and at most three live camera images can be displayed in the area 882. One of these images is located in the center of area 882, and the entire live camera image is accommodated in the area 882. With respect to the other one or two live camera images, only an edge part of these images are accommodated in the area 882. The plurality of live camera images are moved horizontally in response to, for example, a swipe operation made by the user. That is, the live camera image located at the center of the area 882 is switched by the swipe operation made by the user.

At step S508, the receiving unit 210 of the user terminal 30 receives selection of any one of network cameras 40 in the area 882 in response to an operation by the user. Specifically, the live camera image positioned at the center of the area 882 by the user's swipe operation is a live camera image of the network camera 40 selected by the user (hereinafter, simply referred to as “selected live camera image”). The live camera images are arranged in order of distance from the reference point, starting from the live camera images of the network cameras 40 closest to the reference point. As described above, since the live camera images are arranged in order of distance from the reference point, the user can easily select a live camera image to be viewed. Furthermore, not only is there displayed the live camera image of the network camera 40 located at the position closest to the position corresponding to the reference point, but there is also displayed the live camera image of the network camera 40 neighboring the reference point. Accordingly, the user can easily select the live camera image of the place to be viewed. At step S509, the requesting unit 211 of the user terminal 30 requests the server 10 to stream the live camera images selected at step S508. The request includes the identification number of the selected network camera 40.

At step S510, the display control unit 208 of the server 10 controls the user terminal 30 to display the live camera images selected at step S508. Specifically, the display control unit 208 of the server 10 starts streaming the live camera image of the newly selected network camera 40 to the user terminal 30. At this time, if there is a live camera image (a live camera image that has not been newly selected) that has been selected, streaming of the live camera image is stopped.

At step S511, the display unit 209 of the user terminal 30 displays the live camera images using the data received at step S510. That is, at this time, the image object, the map image, and the live camera image are displayed on one display screen. In the screen example shown in FIG. 8, in the area 881, five camera icons (examples of the image objects) 871, 872, 873, 874, and 875 are superimposed on a map of a predetermined scale centered on the current location of the user terminal 30. In other words, five network cameras 40 are installed in the range of the map.

In the area 882, a live camera image 861 and a live camera image 862 are included. In this example, the live camera image 861 is located at the center of area 882 and is the selected live camera image. Only a part (left edge) of the live camera image 862 is shown. In the area 882, the selected live camera image is a video stream (i.e., a live image) and the unselected live camera image is a still image.

The live camera image 862 is an image captured by the network camera 40 corresponding to the icon 871. In the area 881, the icon 871 corresponding to the selected network camera 40 is displayed with an appearance different from those of the icons 872, 873, 874, and 875 corresponding to the unselected network camera 40. In this example, the difference in the appearance is the size of the icons. That is, the icons corresponding to the unselected network cameras 40 are relatively small, while the icons corresponding to the selected network cameras 40 are relatively large. This difference in the appearance makes it easier to identify which network camera 40 is capturing the live camera image being streamed.

The process at step S511 is repeated until the server 10 receives a termination instruction from the user of the user terminal 30. Specifically, until the server 10 receives an instruction to change the reference point from the user of the user terminal 30 or an instruction to end the display of the live camera image displayed at step S511, a latest live camera image is continuously displayed on the user terminal 30.

If the user selects a new live camera image in the area 882 by swiping the live camera image or the like, the processes performed at steps S509 to S511 are performed on the newly selected live camera image.

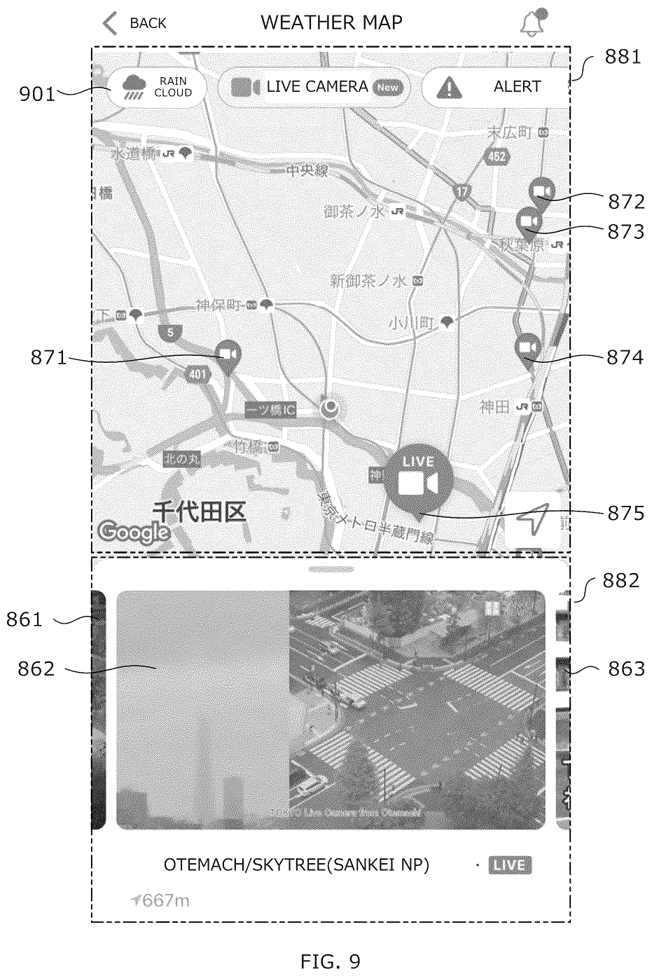

FIG. 9 shows an example of the application screen. The screen illustrated in FIG. 9 is a screen where a swipe operation or the like is performed by the user in the leftward direction on the area 882 in FIG. 8. In FIG. 8, the live camera image 862, which is cut to the right of the area 882, is located at the center of the area 882 in FIG. 9. That is, FIG. 9 shows that the selected live camera image has been switched. If the selected live camera image is switched, the streaming of the live camera image 861 to the user terminal 30 is stopped, and the live camera image 861 to be displayed is switched from a moving image (although it has been cut off) to a still image (or a thumbnail image). The newly selected live camera image 862 is video stream and distributed from the network camera 40 corresponding to the icon 875 on the map. In the area 881, the size of the icon 871 changes to a normal size, and the size of the icon 875 becomes larger. In this example, at this time the display range of the map on which the live camera images is displayed does not change before and after the switching the live camera image.

The user can instruct the change of the reference point or the scale of the map by performing an operation such as dragging, swiping, pinching in, or pinching out on the map in the area 881. If the reference point and/or the scale of the map is changed, the processes at the steps S503 to S510 are repeatedly executed. That is, the user terminal 30 requests the server 10 for the data of the map whose display range has been changed, and the server 10 transmits the requested map data and the live camera image of the network camera 40 included in the display range to the user terminal 30. As described above, the user can view the live camera images of the desired geographical area while switching the images by swiping or the like and changing the reference point and/or scale of the map displayed in the area 881.

The selection of a new live camera image, that is, the switching of the live camera image, is not limited to the method of swiping the live camera image in the area 882. That is, selection of the network camera 40 received by the receiving unit 210 of the user terminal 30 at step S508 is not limited to selection by swiping the live camera images.

For example, the user may tap or click the camera icon displayed superimposed on the map, and as a result the receiving unit 210 receives selection of a new network camera 40. At this time, the user terminal 30 executes a processing depending on the type of operation used to select the new network camera 40. When the operation used to select the new network camera 40 is swiping of the live camera image, the processing is as described above. When the operation used to select the new network camera 40 is “selection of a camera icon on the map,” the processing is as described below.

The requesting unit 203 of the user terminal 30 requests (at step S503) the server 10 to display the map images on the display 3051 of the user terminal 30. The request includes location information or identification information of the newly selected network camera 40 as a parameter related to the map display. The obtaining unit 206 of the server 10 obtains (at step S504) map information corresponding to the location information of the newly selected network camera 40. That is, the display range of the map image is a range centered on the location information of the newly selected network camera 40. The obtaining unit 207 of the server 10 obtains (at step S505) live camera images. At this time, the network camera 40 that is a target for obtaining the live camera image is all of the network cameras 40 located within the newly specified display range. The display control unit 208 of the server 10 controls (at step S506) display of a map image in which image objects are superimposed on the user terminal 30. Upon receiving the data from the server 10, the display unit 209 of the user terminal 30 displays (at step S507) the image object, the map image, and the present live camera image on one display screen.

In this example, if the user taps a camera icon on the map in the user terminal 30 (an icon of the network camera 40 other than the network camera 40 at which the live camera image is currently displayed), the live camera image is switched to an image of the new network camera 40. At this time, the display range of the map is updated to change the newly selected network camera 40 as the reference point (e.g., the center). Further, the image (still image) of the unselected network camera 40 displayed in the area 882 is also updated to correspond to the updated display range of the map.

If the live camera image (for example, the live camera image 862 in FIG. 9) displayed as a moving image is selected on the display screen (FIG. 8 or 9, etc.) of the application, the display unit 209 enlarges the display area of the selected live camera image. In one example, the display unit 209 displays the selected live camera image in full screen (i.e., transitions to full screen view). On the other hand, if a live camera image that is not displayed as a moving image (for example, the live camera image 863 in FIG. 9) is selected, the display unit 209 does not shift the selected live camera image to the full screen view. That is, the display unit 209 restricts the transition to the full-screen view for the live camera image that is not displayed as a moving image.

### 3. Modification

The present invention is not limited to the embodiments described above, and various modifications can be applied. Example modifications will be described below. Two or more items described in the following modifications may be combined.

(1) Combination with geographically distributed information

The live camera image may be displayed in combination with geographically distributed information. The geographically distributed information is, for example, information indicating rain clouds, wind speed, a degree of water increase in a river, a size of a typhoon, and a route, an altitude, a traffic jam situation, a traffic departure, or a route map. In addition, a plurality of types of geographically distributed information may be simultaneously displayed in the map image. Hereinafter, a specific example in which rain cloud information is used as geographically distributed information will be described.

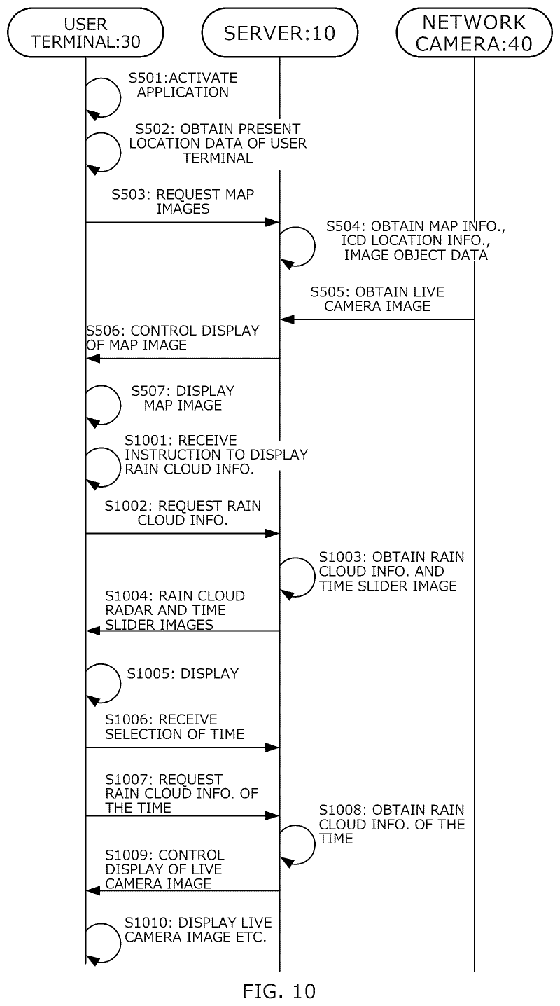

FIG. 10 shows a sequence chart illustrating a one-screen display of a map image and a live camera image with rain cloud information. Unlike the process illustrated in FIG. 5, the process illustrated in FIG. 10 causes the user terminal 30 to display a map image including rain cloud information. The rain cloud information is information indicating a distribution of rain clouds. In addition, the current live camera image is displayed together with the rain cloud radar corresponding to the designated time in accordance with an operation made by the user.

Since the processing from step S501 to step S507 is the same as the processing shown in FIG. 5, explanation thereof is omitted.

At step S1001, the receiving unit 210 of the user terminal 30 receives from the user an instruction to display the rain cloud information. As illustrated in FIG. 9, the map screen includes a rain cloud button 901. If the user taps the rain cloud button 901, the receiving unit 210 receives an instruction to display the rain cloud information.

At step S1002, the requesting unit 211 of the user terminal 30 requests the server 10 for data to display map images including rain cloud information (corresponding to information related to geography). The obtaining unit 212 of the server 10 obtains, from the user terminal 30, a request for data to display a map image including rain cloud information on the display 3051 of the user terminal 30. The rain cloud information is, for example, information indicating a geographical distribution of location information of rain clouds previously existing at a location included in the map image, location information of rain clouds currently existing, location information of rain clouds expected to exist in the future, an actual rainfall amount, and a predicted rainfall amount.

At step S1003, the obtaining unit 206 of the server 10 obtains the rain cloud information and the time slider image from the storage unit 205. The obtained rain cloud information is rain cloud information in the display area specified at step S504. If the rain cloud information in the specified display range is not stored in the storage unit 205, the rain cloud information is obtained from an external server that manages the rain cloud information, and the rain cloud information is stored in the memory 302. The time slider image is an image for prompting the user to select past and future rain cloud information.

At step S1004, the display control unit 208 of the server 10 controls the user terminal 30 to display rain cloud radar and time slider images. Specifically, the display control unit 208 of the server 10 transmits data of the rain cloud information and the time slider image to the user terminal 30.

At step S1005, the display unit 209 of the user terminal 30 displays the image object, the map image, the rain cloud radar, the time slider image, and the present live camera image on one display screen using the data received from the server 10.

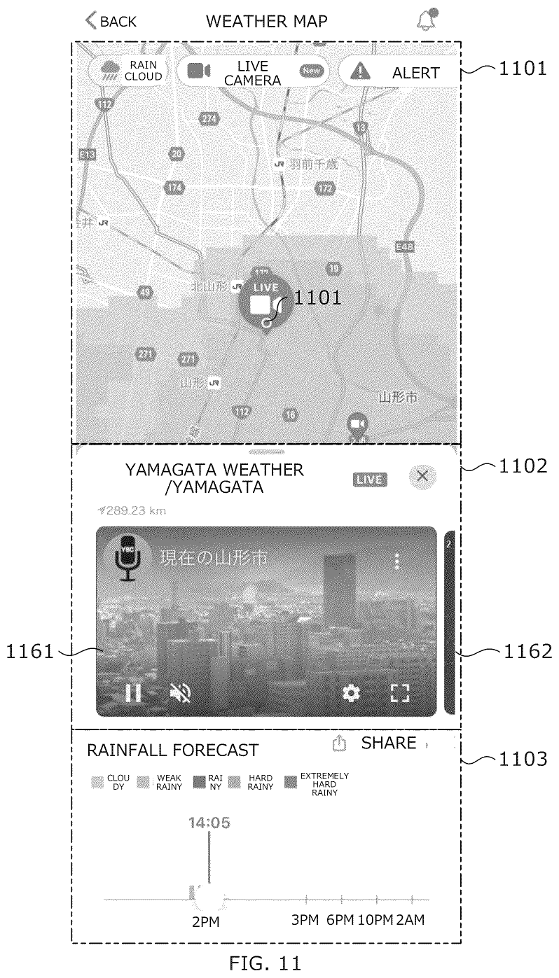

FIG. 11 shows an example of the application screen. The screen includes an area 1101, an area 1102, and an area 1103. The area 1101 is an area for displaying a map image. The area 1102 is an area for displaying a live camera image. The area 1103 is an area for displaying a time slider image. As described above, by displaying the map image on which the rain cloud information is superimposed and the current live camera image, the user can confirm the current rainfall state at the location in the real space of the location corresponding to the map image together with the live camera image. In addition, the user can switch the display to the live camera image of the network camera 40 located in the range of the displayed map by using a swipe operation or the like in the area 1102.

At step S1006, the receiving unit 210 of the user terminal 30 receives selection of a time in response to the user's operation. The operation made by the user is, for example, a touch of a point on the time slider image displayed on the user terminal 30.

At step S1007, the requesting unit 211 of the user terminal 30 requests the server 10 for past or future rain cloud information corresponding to the time when the selection was received at step S1006. The obtaining unit 212 of the server 10 receives, from the user terminal 30, a request for data of past or future rain cloud information corresponding to the time when the selection is received.

At step S1008, the obtaining unit 207 of the server 10 obtains, from the network camera 40, past or future rain cloud data corresponding to the time when the selection was received at step S1006.

At step S1009, the display control unit 208 of the server 10 controls the user terminal 30 to display the previous or future rain cloud data obtained at step S1008. More specifically, the display control unit 208 of the server 10 transmits to the user terminal 30 data of the past or future rain cloud information obtained at step S1008.

At step S1010, the display unit 209 of the user terminal 30 displays the image object, the map image, the time slider image, the present live camera image, and the past or future rain cloud information on one display screen using the data received from the server 10. The display unit 209 controls the user terminal 30 to display the present live camera images at step S1005, and to display the past or future rain cloud data at the time when the selection is received at step S1006.

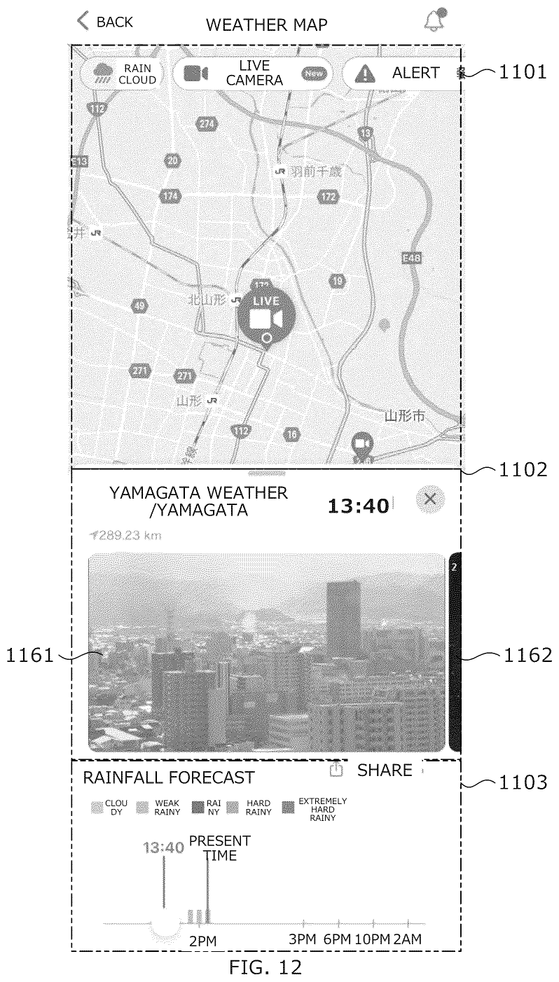

FIG. 12 shows an example of the application screen. As described above, by displaying the map image on which the rain cloud radar is superimposed, the user can check the current live camera image in comparison with the past or future rain cloud information in the location of the real space of the location corresponding to the map image. Thus, the description of the processing illustrated in FIG. 10 is completed.

In addition, as illustrated in FIGS. 11 and 12, the live camera image described with reference to FIGS. 8 and 9 is switched even on a screen on which there are displayed the map image and the live camera image on which the rain cloud information is superimposed.

The receiving unit 210 of the user terminal 30 receives selection of a new network camera 40 different from the network camera 40 selected as a network camera for displaying a moving image in response to an operation made by the user. The operation is, for example, a swipe of a live camera image displayed in the area 1102 or a tap or click of a camera icon superimposed on a map. The user terminal 30 executes processing depending on the type of operation used for selecting the new network camera 40.

In a case that the operation for selecting the new network camera 40 is swiping the live camera image, the processing is as follows. The requesting unit 211 of the user terminal 30 requests (at step S509) the server 10 to stream the selected live camera images. The display control unit 208 of the server 10 controls (at step S510) the user terminal 30 to display the selected live camera images. The display unit 209 of the user terminal 30 displays (at step S511) the live camera images using the data received from the server 10. In this example, if the user swipes the live camera image at the user terminal 30, the live camera image is switched to the image of the new network camera 40. At this time, the display range of the map displayed in superimposition is not changed before and after the switching of the live camera image.

When the operation for selecting the new network camera 40 is selection of the camera icon on the map, the processing is as follows. The requesting unit 203 of the user terminal 30 requests (at step S503) the server 10 to display the map images on the display 3051 of the user terminal 30. The request includes location information or identification information of the newly selected network camera 40 as a parameter related to the map display. The obtaining unit 206 of the server 10 obtains (at step S504) map information corresponding to the location information of the newly selected network camera 40. That is, the display range of the map image is a range centered on the location information of the newly selected network camera 40. The obtaining unit 207 of the server 10 obtains (at step S505) live camera images. At this time, the network camera 40, which is a target for obtaining the live camera image, is all the network cameras 40 located within the newly specified display range. The display control unit 208 of the server 10 controls (at step S506) display of a map image in which image objects are superimposed on the user terminal 30. Upon receiving the data from the server 10, the display unit 209 of the user terminal 30 displays (at step S507) the image object, the map image, and the present live camera image on one display screen. In this example, if the user taps a camera icon on the map (an icon of the network camera 40 other than the network camera 40 at which the live camera image is displayed at that time) in the user terminal 30, the live camera image is switched to an image of the new network camera 40. The display range of the map is updated to change the newly selected network camera 40 as the reference point (e.g., the center). Furthermore, the image (still image) of the unselected network camera 40 displayed in the area 882 is also updated to correspond to the updated display range of the map.

With reference to FIG. 11 and the like, a case has been described in which past or future rain cloud information is displayed by receiving a user's touch at a freely selected position on a time slider image. In addition to this, a similar time slider image may be superimposed and displayed on the currently displayed live camera image 1161. A touch by the user at a freely selected position on the time slider image is received and a past live camera image is displayed. In this case, the obtaining unit 212 of the server 10 receives, from the user terminal 30, a request for data of a past live camera image corresponding to the time when the selection is received. When the obtaining unit 207 of the server 10 obtains the past live camera image corresponding to the received time from the storage unit 215, the display control unit 208 of the server 10 transmits the obtained data of the past live camera image to the user terminal 30. The display unit 209 of the user terminal 30 controls display of the past live camera image at a position where the current live camera image is displayed, by using the past live camera image received from the server 10. As described above, with respect to the live camera image, for example, it is possible to display the past live camera image by receiving the selection of the time by way of the time slider image.

In the foregoing, an example has been described in which a time slider image for selecting past or future rain cloud information, and a time slider image for selecting past live camera images are separately displayed. However, the present invention is not limited thereto, and, for example, a time slider image that can be used for both of the selections may be displayed. In this case, if the selection of the time by the user is received for the time slider image provided in common for the selection of the rain cloud information and the selection of the live camera image, the obtaining unit 207 of the server 10 obtains the rain cloud information and the live camera image corresponding to the time from the storage unit 215, and the display control unit 208 transmits to the user terminal 30 the obtained past rain cloud information and the past live camera image. Then, the display unit 209 of the user terminal 30 controls display of the past rain cloud information and the past live camera image received from the server 10. As described above, the user can easily confirm a state of the live camera image captured at the current time while referring to past rain cloud information. (2) Reference point

The method of determining the reference point of the map is not limited to the example described in the embodiment. In the embodiment, an example in which the current location of the user terminal 30 is used as a reference point, and an example in which the reference point is changed or designated by a user operation on the displayed map have been described. For example, if the application provides a screen for displaying a list of live camera images on the user terminal 30 and the user selects one live camera image on the screen, a map with the location of the network camera 40 taking the live camera image as a reference point may be displayed. Alternatively, a map may be displayed using a point registered in advance by the user (for example, a home or a work place) as a reference point.

In the above-described embodiment, an example has been described in which the display range is set such that the center of the map is the reference point. However, the positional relationship between the display range of the map and the reference point is not limited thereto. For example, the display range may be set such that the upper left end of the map serves as a reference point.

Although an example in which geographically distributed information, a live camera image, and a time slider image are displayed on a map image and one display screen has been described here, the geographically distributed information may be omitted, and the live camera image and the time slider image may be displayed on the map image and one display screen.

(3) Live camera image

The live camera image displayed on the user terminal 30 at step S507 is not limited to the live camera image of all the network cameras 40 installed at the locations included in the display area of the map image. For example, the live camera image displayed at the user terminal 30 may be a live camera image corresponding to a part of the network cameras 40 from among all of the network cameras 40 installed at locations included in the display range of the map image. More specifically, a live camera image captured by some of the network cameras 40 may be displayed in accordance with a distance from the reference point.

The live camera image displayed at step S507 is not limited to the present live camera image, and may be, for example, a still image of a previous live camera image.

The screen configuration of the selection unit that receives the selection of the live camera image is not limited to the example in the embodiment. In the embodiment, only one live camera image is displayed on the selection unit. However, there may be two or more live camera images in which the full screen is displayed. Furthermore, the selection unit is not limited to a carousel type. The selection unit may be of any structure, for example, a tile format or a list format. The order in which the plurality of live camera images are arranged in the selection unit is not limited to the order based on the positional relationship between the reference point and the network camera 40 (for example, the order in which the live camera images are close to the reference point). The plurality of live camera images may be arranged in accordance with an index that is different from the positional relationship between the reference point and the network camera 40; for example, one having a large number of accesses and one having a high user evaluation.

The live camera image selected at step S508 is not limited to one, and two or more live camera images may be selected, for example. In this case, a plurality of selected live camera images may be displayed.

The network camera 40 is not limited to the server 10 and may be a user terminal 30 that responds to a request for displaying the map images at step S509. For example, the user terminal 30 may identify the image object by determining in which image object position coordinates (coordinates of the position on the computer screen) of the position touched by the user on the map image at step S508 are included, and may request the server 10 to provide the current live camera image of the network camera 40 corresponding to the identified image object.

The change in the appearance for distinguishing between the camera icon corresponding to the selected live camera image and the camera icon corresponding to the unselected live camera image is not limited to a change in size. For example, a color of the icons may be changed, a decorative attribute (blinking, etc.) may be changed, or a motion may be changed.

The live camera image displayed on the user terminal 30 is not limited to only one of the current live camera image and the past live camera image. Both the current live camera image and the past live camera image may be displayed together.

The live camera image displayed on the user terminal 30 may or may not include audio. If the live camera image includes audio, the image object displayed on the map may include a UI object for switching the audio output on and off.

The network camera 40 need not be fixed at designated place, and may be mounted to be movable on an unmanned aerial vehicle such as a drone. In this case, the coordinates indicating the location of the network camera 40 in the real space may be three-dimensional coordinates instead of two-dimensional coordinates. Further, the unmanned aerial vehicle periodically provides to the server 10 its own location information. In response, the server 10 updates the camera location information of the network camera database.

The selection of the shooting time of the past live camera image is not limited to the selection using the time slider image displayed on the user terminal 30. For example, a thumbnail image of a still image corresponding to a past live camera image may be displayed on the user terminal 30, and the past live camera image may be displayed as a moving image by selecting the thumbnail image.

The place at which the data of the past live camera image is stored is not limited to the server 10, and may be the network camera 40 or another server. The server 10 may obtain data of past live camera images from these devices.

The position where the live camera image is displayed is not limited to the lower side of the map image. For example, the live camera image may be displayed superimposed on the map. The displayed position may be a position that does not overlap the reference point on the map image. (4) Display of the rain cloud button 901

In a screen example of FIG. 9 or the like, the rain cloud button 901 is displayed on the map screen, and the rain cloud information is displayed by the user tapping the rain cloud button 901. Similarly, although not described in detail, a live camera button and an alarm/warning button are displayed on the map screen, and information corresponding thereto is displayed by the user selection. Selection of the display/non-display may be performed by a method other than tapping by the user on the various buttons illustrated in FIG. 9. For example, a transition may be made to a setting screen or the like, and selection by the user of display/non-display of various kinds of information, such as rain cloud information, a live camera image, an alarm/caution, and the like may be received, and only information selected for display is displayed on the map screen. As described above, the visibility of the map screen can be further improved by not displaying the various buttons on the map screen. (5) Other modifications

In the information processing system S, the correspondence relationship between the functional elements and the hardware is not limited to that illustrated in the embodiment. For example, some of the functions described as the functions of the server 10 in the embodiment may be implemented in another server. Alternatively, some of the functions described as the functions of the server 10 in the embodiment may be implemented in other devices on the network. The server 10 may be a physical server or a virtual server (including cloud computing).

The operation of the information processing system S is not limited to the above-described example. The order of the processing procedures of the information processing system S may be changed in so far as no inconsistency results. In addition, a part of the processing procedure of the information processing system S may be omitted. Furthermore, the request, the obtaining, and the transmission of the image object need not necessarily be performed, and, for example, if a request for the map image is made, the map image on which the image object is superimposed may be obtained, and the map image on which the image object is superimposed may be transmitted.

With respect to the information processing system according to the present invention, in displaying the map, a UI object for displaying geographical information superimposed on the map is displayed, and in response to receiving an instruction via the UI object to display the geographical information, the displayed map is switched to the map on which the geographical information is superimposed.

The various programs illustrated in the embodiments may be provided by being downloaded via a network such as the Internet, or may be provided by being recorded on a computer-readable non-transitory recording medium such as a DVD-ROM (Digital Versatile Disc Read Only Memory).

What is claimed is:

1. A method comprising:
obtaining an image captured by a camera among a plurality of cameras installed at predetermined locations; and
displaying on a display unit a map on which each of a plurality of image objects indicating a location of each of the plurality of cameras are superimposed at a position corresponding to each of the predetermined locations, wherein
the image captured by at least one of the plurality of cameras is displayed on the display unit together with the map.

2. The method according to claim 1, further comprising
receiving a designation of a reference point of the map to display on the display unit of a computer, wherein
the displayed map shows an area corresponding to the reference point.

3. The method according to claim 2, wherein
the displayed image is captured by a camera selected from among the plurality of cameras, the selected camera being selected based on a distance from the reference point.

4. The method according to claim 2, further comprising
obtaining location information of the computer, wherein
the received designation shows the obtained location information as a location of the reference point.

5. The method according to claim 2, wherein
the designation of the reference point is received in response to an input by a user.

6. The method according to claim 2, further comprising
receiving, by a selecting unit, a selection of a camera from among the plurality of cameras, wherein
in displaying the image captured by the selected camera, the image has a different appearance from other images captured by cameras other than the selected camera.

7. The method according to claim 6, wherein
in response to the selection of the camera, the map is shown based on a location of the selected camera as the reference point.

8. The method according to claim 6, wherein
the selecting unit shows, in a carousel format, images captured by the plurality of cameras installed at predetermined locations, and
the selection is received via an input operation on the carousel format.

9. The method according to claim 6, wherein
in the carousel format, the images are arranged in an order of distance of the camera from the reference point.

10. The method according to claim 6, further comprising
receiving a selection of an image object from among the plurality of image objects, wherein
at least two images captured by at least two of the plurality of cameras are displayed on the display unit together with the map, and
in displaying the at least two images, an image captured by a camera corresponding to the selected image object has a different appearance from other images.

11. The method according to claim 2, further comprising
receiving a designation of a position on the map, wherein
at least two images captured by at least two of the plurality of cameras are displayed on the display unit together with the map, and
in displaying the at least two images, an image captured by a camera located at a location nearest to a location corresponding to the designated position is displayed on the map.

12. The method according to claim 6, wherein
in displaying the map, a UI object for displaying geographical information superimposed on the map is displayed, and
in response to receiving an instruction via the UI object to display the geographical information, the displayed map is switched to the map on which the geographical information is superimposed.

13. The method according to claim 12, wherein
in response to receiving the instruction to display the geographical information, the selecting unit shows a screen for selection of an image from among a plurality of images that were previously captured by a camera located at a location nearest to the reference point.

14. The method according to claim 13, further comprising
in response to receiving a selection of the image that was previously captured by the camera located at the location nearest to the reference point, the selected image is displayed on the display unit together with the map.

15. A computer-readable non-transitory storage medium storing a program causing a computer device to execute a process, the process comprising:
obtaining an image captured by a camera from among a plurality of cameras installed at predetermined locations; and
displaying on a display unit a map on which each of a plurality of image objects indicating a location of each of the plurality of cameras are superimposed at a position corresponding to each of the predetermined locations, wherein
the image captured by at least one of the plurality of cameras is displayed on the display unit together with the map.

16. An information processing device comprising:
a processor,
a memory operably connected to the processor, and
a display device operably connected to the processor, wherein
the processor is configured to
obtain an image captured by a camera from among a plurality of cameras installed at predetermined locations, and
control the display device to display a map on which each of a plurality of image objects indicating a location of each of the plurality of cameras is superimposed at a position corresponding to each of the predetermined locations, and the image captured by at least one of the plurality of cameras is displayed on the display device together with the map.

17. A method comprising:
communicating with a user terminal having a display device;
obtaining an image captured by a camera from among a plurality of cameras installed at predetermined locations; and
controlling the display device to display a map on which each of a plurality of image objects indicating a location of each of the plurality of cameras are superimposed at a position corresponding to each of the predetermined locations, wherein
the image captured by at least one of the plurality of cameras is displayed on the display device together with the map.

18. An information processing device comprising:
a processor, and
a memory operably connected to the processor, wherein
the processor is configured to:
communicate with a user terminal having a display device;
obtain an image captured by a camera from among a plurality of cameras installed at predetermined locations; and
control the display device to display a map on which each of a plurality of image objects indicating a location of each of the plurality of cameras are superimposed at a position corresponding to each of the predetermined locations,
wherein
the image captured by at least one of the plurality of cameras is displayed on the display device together with the map.
